(19) United States
(12) Patent Application Publication
(10) Pub. No.: US 2010/0133394 A1
(43) Pub. Date: Jun. 3, 2010

(54) FOLDABLE HANDBAG HANGER

(76) Inventor: Tatiana Chvetsova, London (GB)

Correspondence Address: PEARNE & GORDON LLP, 1801 EAST 9TH STREET, SUITE 1200, CLEVELAND, OH, 44114-3108, US

(21) Appl. No.: 12/528,812

(22) PCT Filed: Jan. 9, 2008
(86) PCT No.: PCT/EP2008/050201

§ 371 Date: Feb. 15, 2010

(30) Foreign Application Priority Data
Feb. 27, 2007 (EP) 07103155.3

(51) Int. Cl. F16M 13/00

(52) U.S. Cl. 248/95

(57) ABSTRACT

Foldable hanger 1 for suspending a handbag from a horizontal surface 6, the foldable hanger 1 having an open position and a closed position, and comprising:—a base part 2 for resting on the horizontal surface 6 and—a foldable hook 3 attached to the base part 2, the hook 3 hanging over the edge of and below the horizontal surface 6 when the hanger 1 is in its open position and the base part 2 rests on the horizontal surface 6, the hook 3 being stored within the base part 2 when the hanger 1 is in its closed position.

The present invention relates to a hanger for suspending objects to a horizontal surface. The present invention relates in particular to a foldable handbag hanger for suspending handbags to a table.

Handbag hangers are used for example to avoid having to put a handbag on the floor of public places such as restaurants, cafes and the like. Handbag hangers usually comprise a hook to which the handbag can be suspended, and a base part to which the hook is attached. The base part comprises a usually non slippery contact surface with which it can be placed on a flat surface, for example on a table. The hook is disposed in such a manner that it hangs below the flat surface.

In order to reduce their size when they are not in use, some handbag hangers can be folded, thus making their handling and transport in small handbags easier.

The foldable hangers of the prior art, however, are relatively big when folded, so that they remain quite unpractical. The hook is also often accessible when the hanger is folded, so that it can hold onto other things when stored away for example in a handbag, and it can pull open by itself when taken out of the handbag again.

An aim of the present invention is to propose a foldable handbag hanger overcoming the drawbacks of the prior art foldable handbag hangers.

Another aim of the present invention is to propose a foldable handbag hanger that can be easily transported even in small handbags.

Another aim of the present invention is to propose a foldable handbag hanger with a reduced risk of involuntarily holding onto other objects and/or of involuntarily unfolding.

These aims are achieved by the object of claim 1, preferred embodiments of the invention being disclosed in the dependent claims.

These aims are achieved in particular with a foldable hanger for suspending a handbag from a horizontal surface, the foldable hanger having an open position and a closed position, and comprising:
a base part for resting on the horizontal surface and
a foldable hook attached to the base part, the hook hanging over the edge of and below the horizontal surface when the hanger is in its open position and the base part rests on the horizontal surface,
the hook being stored within said base part when said hanger is in its closed position.

In its closed position, the foldable hanger of the invention can be made very compact, thus practical to be carried for example in small handbags. In its closed position, the external shape of the hanger of the invention is basically determined by the external shape of the base part that can be made as smooth as desired in order to avoid the folded hanger to involuntarily hold onto other objects when carried for example in a handbag. The base part of the handbag hanger being furthermore at least big enough to contain the folded hook, it is sufficiently big relative to the other parts of the hanger, and its contact surfaces are large enough, to provide a good balance and stability to the hanger when a handbag is suspended to it.

Preferably, the base part forms a casing with only one open side for entering the foldable hook into the base part when the hanger is brought from its open position to its closed position. In an embodiment, the foldable hook is then entirely stored within the base part when the hanger is in its closed position. In another embodiment, a relatively small portion of the foldable hook protrudes out of the base part when the hanger is in its closed position for facilitating the opening of the hanger.

Preferably, the hanger comprises a latch mechanism for holding the foldable hook within the base part when the hanger is in its closed position. It can then comprise an actuator for actuating the latch mechanism and releasing the foldable hook outside the base part.

The hanger of the invention can also comprise a spring for forcing the foldable hook out of the base part and/or for forcing the foldable hook into the base part.

Preferably, the foldable hook comprises segments pivotally attached to each other, for example rigid segments.

In an embodiment, the segments form a chain, or the foldable hook comprises an elongated part of a flexible material. The hanger then preferably comprises a drum pivotally attached inside of the base part for at least partly rolling the foldable hook around the drum when the hanger is in its closed position. Preferably, the foldable hook is attached with one end to the drum.

According to a variant, the hanger then has more than one open position, each open position corresponding to another length of the foldable hook extending outside of the base part.

In another embodiment, the foldable hook is folded inside the base part when the hanger is in its closed position.

The invention will be better understood by reading the description below, with the help of the appended figures, where:

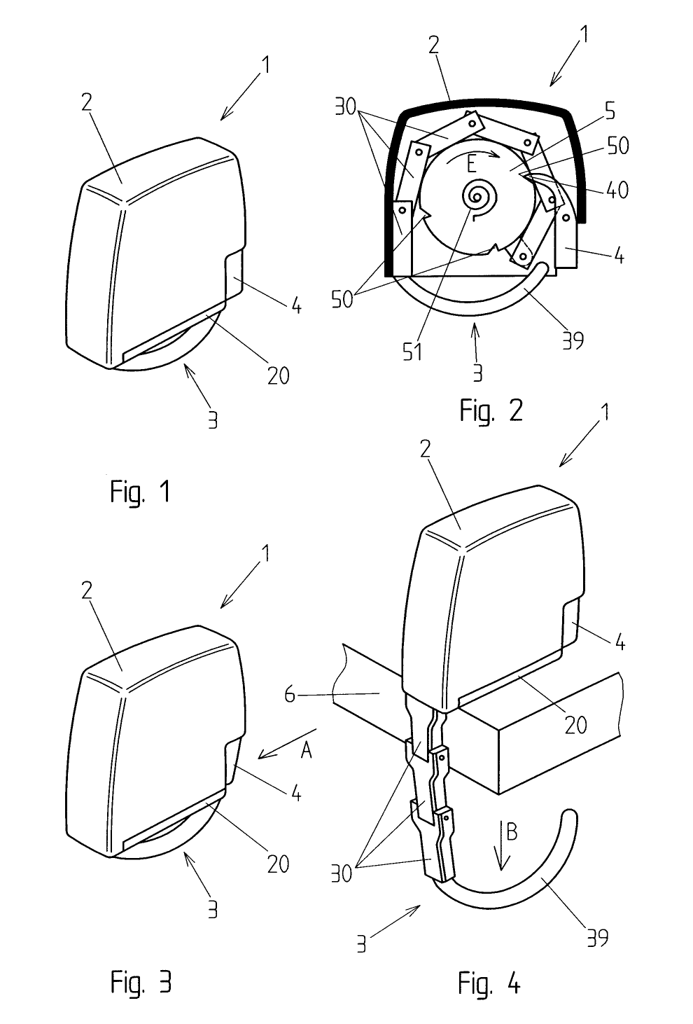

FIG. 1 is a perspective view of a hanger according to an embodiment of the invention in its closed position,

FIG. 2 is a cut view of the hanger of FIG. 1 in its closed position,

FIG. 3 illustrates the opening of the hanger of FIG. 1,

FIG. 4 shows the hanger of FIG. 1 in a first open position,

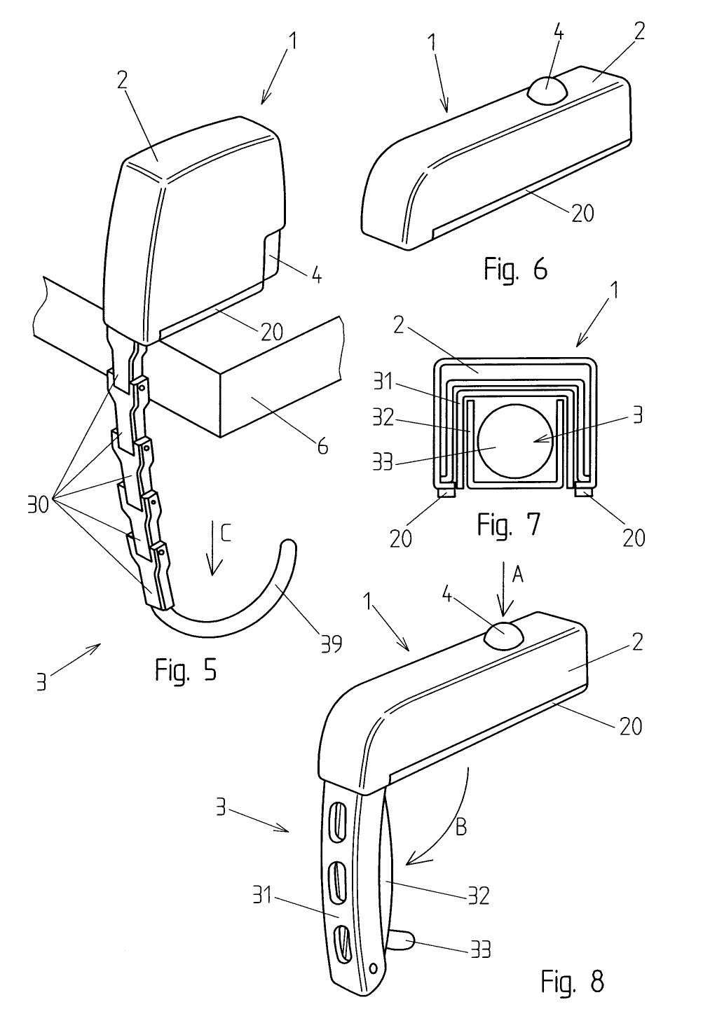

FIG. 5 shows the hanger of FIG. 1 in a second open position,

FIG. 6 is a perspective view of a hanger according to another embodiment of the invention in its closed position,

FIG. 7 is a cut view of the hanger of FIG. 6 in its closed position,

FIG. 8 illustrates the opening of the hanger of FIG. 6,

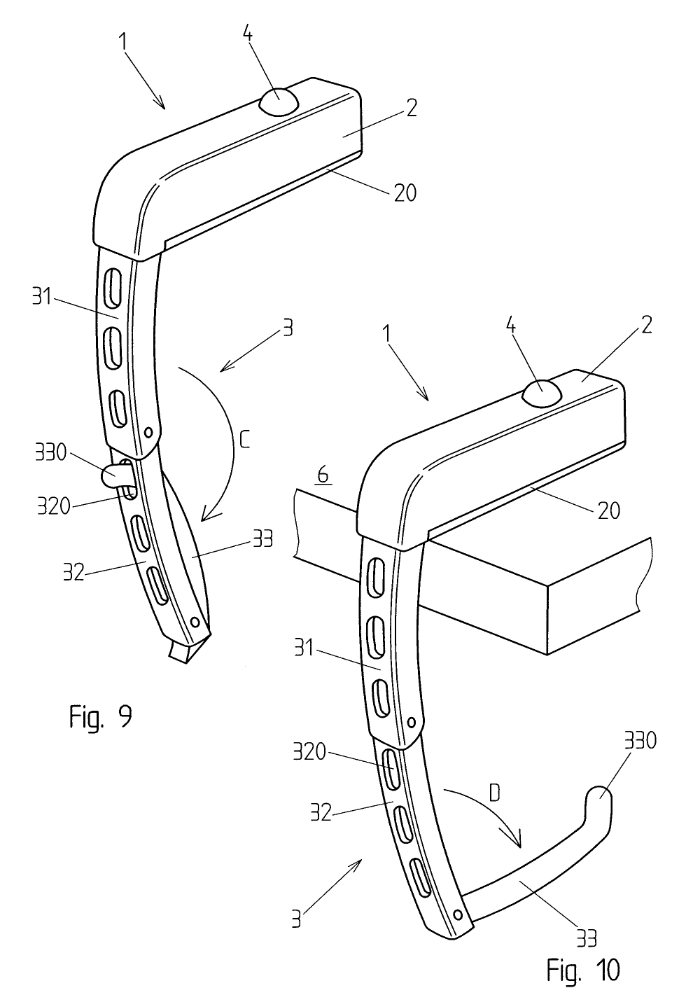

FIG. 9 illustrates a further step in the opening of the hanger of FIG. 6,

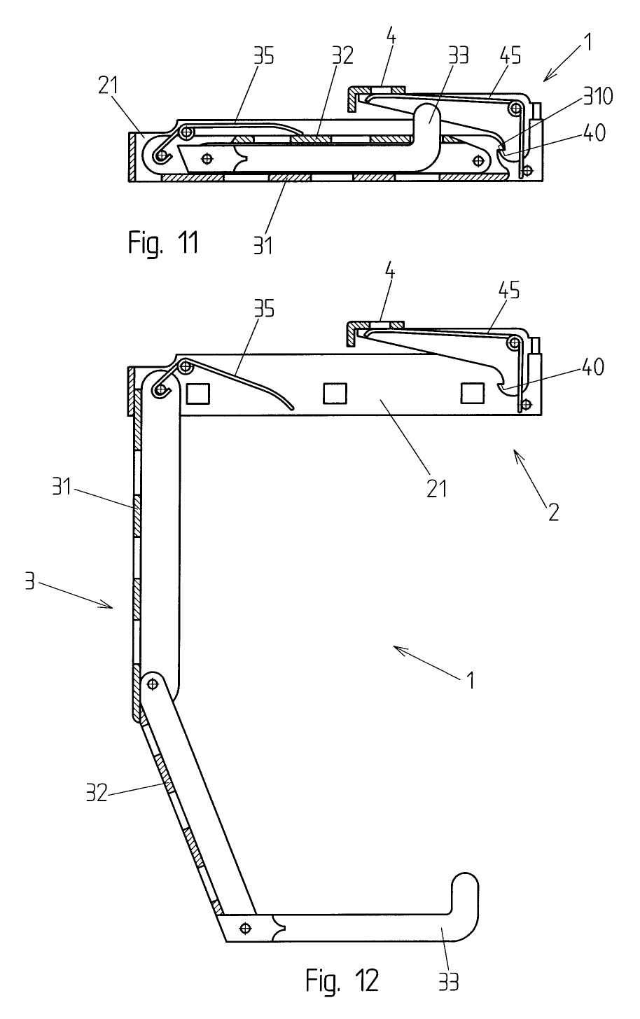

FIG. 10 shows the hanger of FIG. 6 in its open position,

FIG. 11 is a cut view of a variant embodiment of the hanger of FIG. 6 in its closed position,

FIG. 12 is a cut view of the hanger of FIG. 11 in its open position.

Without other indications, like references indicate like components in all figures.

According to the invention, and with reference to the figures, the handbag hanger 1 of the invention comprises a base part 2 and a foldable hook 3 attached to the base part 2. The base part 2 preferably comprises a mechanism, for example a mechanical structure to which the foldable hook is directly attached, and a cover placed over the mechanism and participating to the aesthetical aspect of the hanger 1. In an embodiment, the cover can be detached from the mechanism and replaced by another cover having a different aspect. The hanger of the invention can thus be customized, preferably by the user himself, and matched for example to a particular handbag, a dress, etc. The user can for example have several plastic covers of different colours, one or two covers in a precious material, for example in gold, possibly with precious stones and/or enamels, etc.

The hanger 1 can be moved from a closed to an open position. In the closed position, the foldable hook 3 is preferably entirely stored inside the base part 2. Optionally, a small part of the hook 3 can protrude from the base part 2 in order to provide for a small grip facilitating the opening of the hanger 1. Optionally, the hanger 1 comprises a latch mechanism for holding the hook 3 in its closed position. The latch mechanism can for example be released through an actuator, for example through a pushbutton 4 positioned on a side of the base part 2.

In the open position, the foldable hook 3 extends away from the base part 2. The shape of the hanger 1 in its open position is preferably similar to that of a C. The base part 2 can then be positioned to rest on a horizontal surface 6, for example on a table, while the hook 3 hangs over the edge of and below the surface 6. A handbag or other personal belongings, not represented, can then be suspended to the hook 3, below the horizontal surface 6.

FIG. 1 shows a hanger 1 according to an embodiment of the invention, in its closed position. According to this embodiment, the base part 2 forms a parallelepiped casing with five closed sides. In the closed position, the hook 3 is stored within the casing formed by the base part 2. Preferably, a relatively small part of the hook 3 protrudes out of the open side of the base part 2, thus offering a grip to the hook 3 in order to facilitate the opening of the hanger 1 by pulling the hook out of the base part 2, preferably while simultaneously releasing a locking mechanism.

FIG. 2 is a cut view of the hanger 1 of FIG. 1 showing how the foldable hook 3 is stored inside the base part 2. According to this embodiment, the hook 3 comprises a series of segments 30 pivotally attached to each other and forming a chain. On one end, the chain is terminated by a last segment 30 comprising a preferably curved element 39, to which a handbag, not represented, can be suspended. In a variant embodiment, the last segment 30 of the one end of the chain is fixed to the element 39 for suspending a handbag. On its other end, the chain is attached to a drum 5 located inside the base part 2. Preferably, the drum 5 is pivotally attached around its centre inside the base part 2. When the hanger 1 is in its closed position, the chain is at least partially rolled around the drum 5.

Optionally, the hanger 1 of the invention comprises a spring 51 to hold the hook 3 within the base part 2, for example a spring 51 placed around the rotation axis of the drum 5 and forcing it into the closed position of the hanger 1, as illustrated by the arrow E. The hanger 1 also preferably comprises a latch mechanism comprising for example a grip 40 coupled to a pushbutton 4, the grip 40 cooperating with notches 50 of the drum 5 for holding the drum 5 and thus the foldable hook 3 in predetermined positions, each notch 50 or pair of notches corresponding for example to another predetermined position. The latch mechanism is released by applying a pressure on the pushbutton 4 as illustrated by the arrow A on FIG. 3.

Once the drum 5 is released by pushing on the pushbutton 4, the hanger 1 can be brought into its open position, for example by pulling on the curved element 39 of the foldable hook 3. Preferably, the hanger 1 of the invention can take on more than one open position, as illustrated in FIGS. 4 and 5, each open position corresponding to a different length of the foldable hook 3 extending outside the base part 2, in order to adapt the hanger 1 of the invention to tables or other surfaces of different thicknesses. The different open positions preferably correspond to predetermined positions in which the drum 5 is held by the latch mechanism, so that these positions are stable positions with a determined length of the foldable hook 3 extending outside the base part.

When the hanger 1 is in one of its open positions, the base part 2 can be placed to rest on a horizontal surface 6, for example on a table, and oriented so that the hook 3 hangs over the edge of and below the surface 6. The base part 2 preferably comprises a contact surface 20, preferably a non-slippery contact surface, for example covered with a rubbery material, for providing the base part 2 with a good grip onto the surface 6 and thus preventing the base part 2 from slipping on the horizontal surface 6 and the hanger 1 from falling of the table when a handbag, for example, is suspended to it.

In order to improve the stability of the hanger when the base part 2 is placed on a horizontal surface 6 and an object is suspended to the foldable hook 3, the angle of rotation between two adjacent rigid elements 30 is preferably limited. From the position where the rigid elements 30 are aligned to form an essentially straight line, the chain can thus be bent in one direction in order to allow it to be rolled onto the drum 5, but can preferably not be bent in the other direction, thus avoiding that the suspended object be pushed away from the surface 6 and/or swung, which would unbalance the base part 2 and eventually make it fall from the surface 6. The rotation angle between two adjacent segments 30 is preferably limited by the profile of the segments 30 themselves. The rotation angle between two adjacent rigid elements 30 is for example limited to a range of approximately 120 degrees, 90 degrees, or even 45 degrees.

In the illustrated example, the foldable hook 3 comprises a chain comprising a series of rigid elements 30 pivotally attached to each other. The elements 30 are for example made of metal, plastic, or any other suitable rigid material. In an alternative embodiment, the foldable hook is made of a band of a flexible material, for example of a flexible synthetic material such as rubber or any other suitable material, which is rolled over the drum when the hanger is in its closed position.

According to another embodiment illustrated on FIG. 6, the hanger 1 comprises a base part 2 forming an elongated casing closed on five sides. In its closed position, the foldable hook is folded on itself and completely stored inside the base part 2.

According to this embodiment, the hook 3 comprises a first and a second preferably rigid segments 31, 32 having a U-shaped profile (FIG. 7). The first segment 31 is pivotally attached at a first end to the base part 2 and at a second end to the second rigid segment 32. The second segment 32 is pivotally attached at its first end to the first rigid segment 31, and at its second end to a third segment 33 for suspending for example a handbag, not represented, when the hanger is in its open position. The dimensions of the three rigid segments 31, 32, 33 and the base part 2 are such that, when the hanger 1 is in its closed position, the third segment 33 is placed within the second segment 32, which in turn is placed within the first segment 31. The so folded hook 3 is then stored inside the base part 2, as illustrated in FIG. 7 which is a transversal cut view of the hanger of FIG. 6.

Preferably, the hanger 1 comprises a latch mechanism for holding the folded hook 3 within the base part 2, thus avoiding an involuntary opening of the hanger 1. The latch mechanism (not represented on FIG. 6-10) is released through an actuator, for example through a pushbutton 4 located on one of the external sides of the base part 2.

When the pushbutton 4 is pushed, as illustrated in FIG. 8 by the arrow A, and the latch mechanism is released, the first rigid segment 31 can be pulled out of the base part 2 and pivoted until it forms an approximately right angle with the base part 2, as illustrated by the arrow B. Preferably, the hanger 1 of the invention comprises a spring mechanism so that the first rigid segment 31 comes out of the base part 2 by itself when the pushbutton 4 is pushed. The second rigid segment 32 is then pulled out of the first segment 31 until it is substantially aligned with the first segment 31, as illustrated by the arrow C in FIG. 9. The third segment 33 is then pulled out of the second segment 32 until it approximately forms a right angle with the second segment 32, as illustrated by the arrow D in FIG. 10. The shape of the hanger 1 in its open position is thus similar to that of a C. The base part 2 can then be positioned to rest on a horizontal surface 6, for example on a table, so that the foldable hook 3 hangs over the edge of and below the surface 6.

The maximal angles formed between the base part 2 and the first segment 31 and between the respective segments 31, 32, 33 of the foldable hook 3 are preferably limited, for example by the profiles of the segments 31, 32, 33 and of the base part 2. These maximal angles are chosen so that the hanger 1 is correctly balanced when the base part 2 is placed on the flat surface and for example a handbag, not represented, is suspended to the hook 3.

The third segment 33 is preferably an elongated element with a circular cross-section in order to avoid damaging the objects that are suspended to it, in particular the handles of handbags. Its loose end 330 is preferably slightly bent in order to prevent the suspended objects from slipping and falling off the hook 3. A hole 320 is preferably foreseen in the profile of the second segment 32 in order to lodge the bent end 330 of the third segment 33 when the foldable hook 3 is folded, as illustrated for example on FIG. 9.

The base part 2 comprises one or more contact surfaces 20, for example the edges of its casing along its opened side, that are preferably covered with a non-slippery material preventing the base part form slipping on the horizontal surface when a handbag is suspended to the hook 3.

FIGS. 11 and 12 are cut views of a preferred embodiment of the hanger 1 of the invention respectively in its closed and open position. Out of clarity, the base part 2 of the hanger 1 is illustrated without cover.

The mechanism of the hanger 1 comprises a chassis 21 to which a cover, not represented, can be fixed, preferably in a detachable manner so that the cover of the hanger can be changed by the user.

According to this preferred embodiment, the hanger 1 comprises a latch mechanism for holding the foldable hook 3 in its folded position inside the base part when the hanger 1 is in its closed position. The latch mechanism comprises a pushbutton 4 connected to a grip 40 that cooperates with a notch 310 made in one of the segments of the foldable hook, for example in the first segment 31. The latch mechanism preferably comprises a spring 45 for bringing back the pushbutton 4 in its initial position once the pressure on the pushbutton 4 is released. As illustrated in FIGS. 11 and 12, the pushbutton 4 preferably further comprises a stopper extending below said pushbutton 4 for limiting its displacement when it is pushed by a user.

When a cover is fixed on the chassis 21, the pushbutton 4 protrudes through an opening of the cover and/or is covered by a preferably flexible part of said cover, thus allowing a user to push on the pushbutton 4 and thereby activate the latch mechanism.

The hanger 1 preferably comprises a spring 35 for automatically forcing the foldable hook 3 out of the base part when the pushbutton 4 is pushed and the latch mechanism is released.

FIG. 12 further shows how the profiles of the chassis 21 and of the segments 31, 32 and 33 of the hook 3 cooperate to limit the maximal angle between the respective elements when the hanger 1 is in its open position in order to ensure a stable position of the hanger 1 when it is placed on a flat surface and a handbag is suspended to it.

Except for the contact surfaces 20, the hanger 1 of the invention is preferably mostly made of rigid materials in order to provide it with sufficient rigidity to be stable when a handbag is suspended to it. Nevertheless, the hanger 1 of the invention can be made of very different materials, and different parts can be made of different materials.

The cover on the base part 2, and possibly some other parts such as the segments 30 or 31, 32, 33 of the foldable hook 3, can for example be made of a precious metal such as gold, platinum, etc. These parts can be decorated, for example with enamels, gems, etc. The hanger 1 of the invention can thus be turned into a piece of jewellery.

Alternatively, the materials can be chosen to be light in weight in order to make the hanger 1 of the invention as handy and discrete as possible. The materials can also be chosen to be cheap in order to make the hanger 1 of the invention available to every budget.

1. A foldable hanger (1) for suspending a handbag from a horizontal surface (6), said foldable hanger (1) having an open position and a closed position, said foldable hanger (1) comprising:
a base part (2) for resting on the horizontal surface (6) and
a foldable hook (3) attached to said base part (2), said hook (3) hanging over the edge of and below said horizontal surface (6) when said hanger (1) is in its open position and said base part (2) rests on said horizontal surface (6),
wherein said hook (3) is stored within said base part (2) when said hanger (1) is in its closed position.

2. The hanger (1) of claim 1, wherein said base part (2) forms a casing with only one open side for entering said foldable hook (3) into said base part (2) when said hanger (1) is brought from its open position to its closed position.

3. The hanger (1) of claim 1 wherein said base part (2) comprises a mechanism (5) and a cover, said hook (3) being attached to said mechanism (5).

4. The hanger (1) of claim 3, wherein said cover is removably attached to said mechanism (5).

5. The hanger (1) of claim 1 wherein said foldable hook (3) is entirely stored within said base part (2) when said hanger is in its closed position.

6. The hanger (1) of claim 1, wherein a relatively small portion of said foldable hook (3) protrudes out of said base part when said hanger (1) is in its closed position for facilitating the opening of said hanger (1).

7. The hanger (1) of claim 1, further comprising a latch mechanism (40, 50) for holding said foldable hook (3) within said base part (2) when said hanger (1) is in its closed position.

8. The hanger (1) of claim 7, further comprising an actuator (4) for actuating said latch mechanism (40, 50) and releasing said foldable hook (3) outside said base part (2).

9. The hanger (1) of claim 8 further comprising a spring for forcing the foldable hook (3) out of said base part (2).

10. The hanger (1) of claim 1, further comprising a spring (51) for forcing the foldable hook (3) into said base part (2).

11. The hanger (1) of claim 1, wherein said foldable hook (3) comprises segments (30; 31, 32, 33) pivotally attached to each other.

12. The hanger (1) of claim 11, wherein the range of the rotation angle between two adjacent segments is limited.

13. The hanger (1) of claim 11, wherein said segments (30; 31, 32, 33) are rigid segments.

14. The hanger (1) of claim 11, wherein said segments (31, 32, 33) form a chain.

15. The hanger (1) of claim 14, wherein the range of the rotation angle between two adjacent segments is limited so that said chain can be rolled in one direction only.

16. The hanger (1) of claim 1 wherein said foldable hook (3) comprises an elongated part of a flexible material.

17. The hanger (1) of claim 14, further comprising a drum (5) pivotally attached inside of said base part (2) for at least partly rolling said foldable hook (3) around said drum (5) when said hanger (1) is in its closed position.

18. The hanger (1) of claim 17, wherein said foldable hook (3) is attached with one end to said drum (5).

19. The hanger (1) of claim 14, having more than one open position, each open position corresponding to another length of said foldable hook (3) extending outside of said base part (2).

20. The hanger (1) of claim 1, wherein said foldable hook (3) is folded inside said base part (2) when said hanger (1) is in its closed position.
